(19) United States
(12) Patent Application Publication
(10) Pub. No.: US 2020/0100478 A1
(43) Pub. Date: Apr. 2, 2020

(54) SCRAPER SYSTEM

(71) Applicant: Duard Enoch, Santa Barbara, CA (US)

(72) Inventor: Duard Enoch, Santa Barbara, CA (US)

(21) Appl. No.: 16/586,096

(22) Filed: Sep. 27, 2019

Related U.S. Application Data
(60) Provisional application No. 62/737,641, filed on Sep. 27, 2018.

(51) Int. Cl. A01K 63/10; B08B 1/00

(52) U.S. Cl. CPC A01K 63/10; B08B 1/005

(57) ABSTRACT

A scraper for use with aquariums incorporates a body having a slot adapted to removably receive a scraping element and a handle extending form the body. The handle has at least two removable and adjustable links.

### REFERENCE TO RELATED APPLICATIONS

This application claims priority of US provisional application Ser. No. 62/737,641 filed on Sep. 27, 2019 entitled SCRAPER SYSTEM, the disclosure of which is incorporated herein by reference.

### BACKGROUND INFORMATION

### Field

Implementations of the disclosure relate generally scraping devices for cleaning aquarium walls and, more particularly, a scraper adapted to receive a removable scraping element and having multiple adjustable handle lengths and positions.

### Background

Aquarium owners clean the walls of their aquariums with various scraping devices. A simple, adjustable device is desirable.

### SUMMARY

Implementations disclosed herein provide a scraper having a body receiving a removalbe scraping element and a handle with adjustable and removable links.

### BRIEF DESCRIPTION OF THE DRAWINGS

The features, functions, and advantages of the anti-personnel autonomous vehicle can be achieved independently in various implementations of the present disclosure or may be combined in yet other implementations further details of which can be seen with reference to the following description and drawings.

FIG. 1 is a pictorial representation of an implementation of the present disclosure;

FIG. 2 is a detailed pictorial representation of the scraper body;

FIG. 3 is a top view of the scraper body; and,

FIG. 4 is a pictorial representation of a multibladed scraper element.

### DETAILED DESCRIPTION

Implementations disclosed herein provide a scraper having a body adapted to receive a removable scraper element. The scraper element may be a plastic card, such as a credit card, that is received in a slot in the body with an edge protruding to provide the scraping surface. A handle extends from the body and having two or more links which are interconnected to provide various angular positioning of the body.

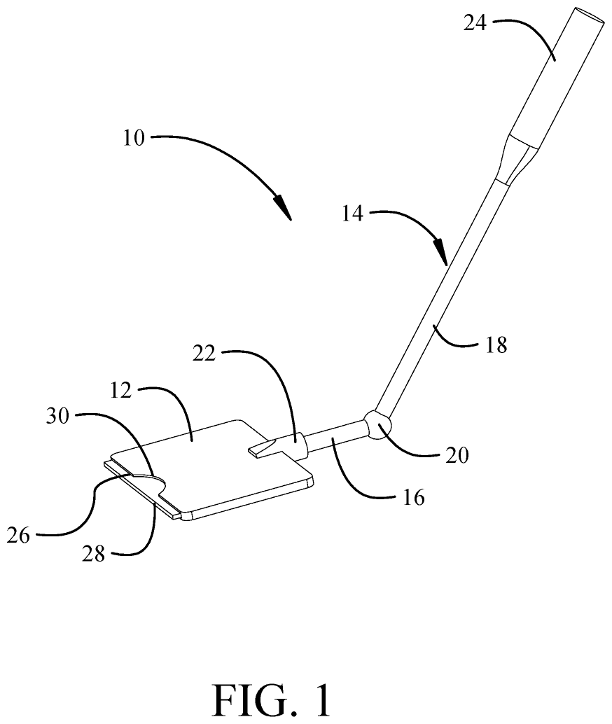

Referring to the drawings, FIG. 1 shows a scraper 10 having a body 12 with an extending handle 14. The handle 14 has an attachment link 16 and an extension link 18. A universal joint 20 connects the attachment link 16 and extension link 18 to allow adjustment of the angular relationship between the links for positioning of the body at a desired angle. The attachment link is engaged to the body in a boss 22. For the exemplary implementation the extension link terminates in a grip 24. The extension link 18 may be disconnected from the attachment link 16 at the universal joint and the attachment link may be disconnected from the boss 22 to provide differing lengths of the handle allowing the user to grip and manipulate the body of the scraper in a variety of ways.

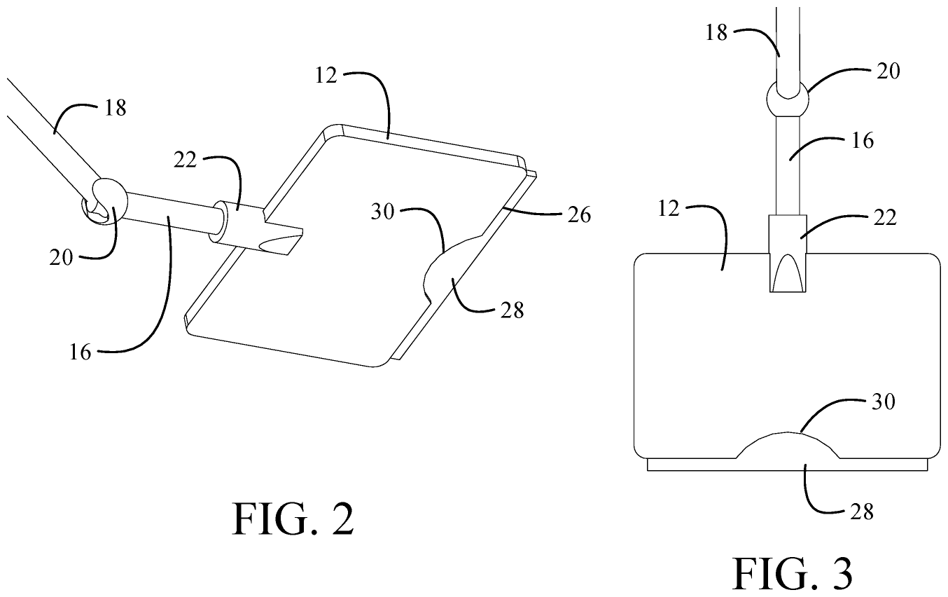

As seen in FIGS. 2 and 3, the body 12 has a slot 26 which is sized to closely receive the scraping element 28. A resiliently pliable card such as a credit card may be employed as the scraping element 28. The slot has a relief 30 to allow grasping the scraping element for removal from the slot 26.

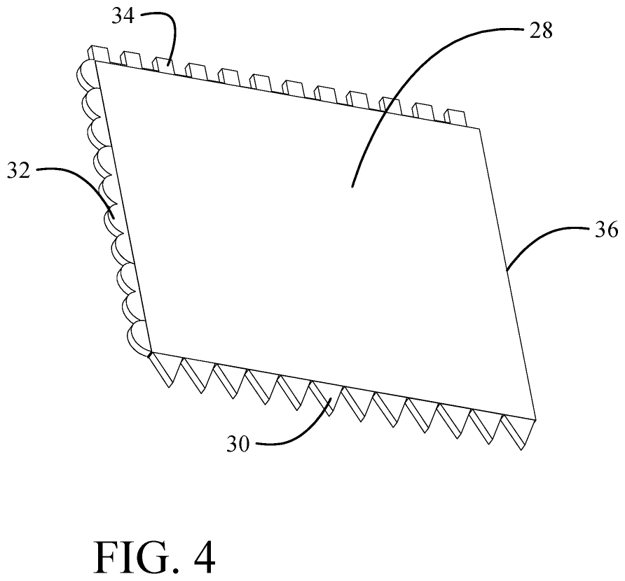

As seen in FIG. 4, the scraping element 28 may have a plurality of edges with differing contours such as a serrated edge 30, a scalloped edge 32, a toothed edge 34 and a flat edge 36. Thickness of the scraping element 28 is exaggerated for clarity. Selection of the desired edge at insertion of the scraping element into the slot allows various cleaning capability for algae, mineral buildup, scale or dirt that may accumulate on the aquarium wall.

While a plastic material may be applicable for most requirements of the scraping element, a thin stainless steel or other metallic material may be employed to enhance the durability and capability of the scraping element.

Having now described various implementations of the disclosure in detail as required by the patent statutes, those skilled in the art will recognize modifications and substitutions to the specific implementations disclosed herein. Such modifications are within the scope and intent of the present disclosure as defined in the following claims.

What is claimed is:

1. A scraper for use with aquariums, said scraper comprising:
a body having a slot adapted to removably receive a scraping element;
a handle extending form the body and having at least two removable and adjustable links.

2. The scraper as defined in claim 1 wherein the at least two removable and adjustable links comprise an attachment link and an extension link and further comprising a universal joint connecting the attachment link and extension link to allow adjustment of the angular relationship between the links for positioning of the body at a desired angle.

3. The scraper as defined in claim 2 wherein the extension link is disconnectable from the attachment link at the universal joint and the attachment link is disconnectable from the boss to provide differing lengths of the handle.

4. The scraper as defined in claim 1 wherein the scraping element comprises a resiliently pliable card.

5. The scraper as defined in claim 1 wherein the slot sized to closely receive the scraping element and has a relief to allow grasping the scraping element for removal from the slot.

6. The scraper as defined in claim 1 wherein the scraping element has a plurality of edges with differing contours.

7. The scraper as defined in claim 6 wherein each of the plurality of edges is selected from s a serrated edge, a scalloped edge, a toothed edge and a flat edge.
